(19) United States
(12) Patent Application Publication
(10) Pub. No.: US 2010/0012634 A1
(43) Pub. Date: Jan. 21, 2010

(54) METHOD FOR CUTTING OR PERFORATING FILM

(75) Inventor: Steven Caldecott, Ayr (GB)

Correspondence Address: SCHUBERT OSTERRIEDER & NICKELSON PLLC, 6013 CANNON MTN DR, S14, AUSTIN, TX, 78749, US

(73) Assignee: GR ADVANCED MATERIALS LTD., Stirling (GB)

(21) Appl. No.: 12/544,387

(22) Filed: Aug. 20, 2009

(30) Foreign Application Priority Data
Feb. 23, 2007 (GB) 0703552.0
Feb. 21, 2008 (GB) PCT/GB2008/000593

(51) Int. Cl. B23K 26/38

(52) U.S. Cl. 219/121.72

(57) ABSTRACT

A method of cutting or perforating a thin film (10) comprises the steps of applying an energy-absorbing material (14) at a selected location (15) or at selected locations (11) on a surface of the film, wherein the energy-absorbing material absorbs electromagnetic energy in a predetermined frequency range. Further, the method includes irradiating the energy-absorbing material at said location or said selected locations with a laser of sufficient energy in the predetermined frequency range, so as to heat the energy-absorbing material to an extent that a portion of the film adjacent to the energy-absorbing material is removed, thereby cutting the film or generating a perforation in the film.

### CROSS-REFERENCE TO RELATED APPLICATIONS

This application claims priority to GB patent application no. 0703552.0 filed on Feb. 23, 2007, and PCT international patent application no. PCT/GB2008/000593 filed Feb. 21, 2008, wherein the contents of both applications are hereby incorporated in their entireties.

### FIELD OF DISCLOSURE

The present disclosure relates to the cutting of or the formation of perforations, or apertures, in film materials. The present disclosure is particularly, but not exclusively, concerned with cutting or perforation of polymer films.

### BACKGROUND

Polymer films are widely used in the semiconductor packaging industry, often used as barrier layers and interconnect layers when mounting integrated circuits and other devices onto or into packages. Such polymer films conventionally carry surface electrical interconnects and require apertures at predetermined positions on the film to allow electrical connections to be made through the otherwise electrically insulating film.

Perforated films have a wide variety of other uses in medical, electrical, clothing, food and industrial fields, and may be used as barrier layers and semi-permeable membranes in filters for example.

Conventionally, the formation of perforations, or apertures, in film materials can be achieved by a number of methods, such as chemical and/or physical etching, as well as mechanical removal, such as punching. Mechanical methods generally have limited accuracy and resolution and may be unsuitable for films having a thickness of 5 μm or less, particularly for very thin films, e.g., those below 1 μm in thickness. Chemical and/or physical etching processes generally require more complex and expensive processing apparatuses and multi-step processes, such as photolithography in order to define etch masks on the thin films determining where apertures are subsequently formed.

Self-supporting films of the type commonly used in semiconductor packaging may be formed as large sheets or rolls prior to being cut, and thus it is desirable that any aperture-forming process is fully compatible with a mechanical continuous feed mechanism capable of operating at speed and with the required degree of accuracy.

Many chemical and physical etching processes capable of defining small apertures with high precision are incompatible with such continuous feed type mechanisms.

It would be highly desirable to achieve cutting or perforation, for instance in the form of very fine geometric patterns of apertures, of large films at high speed and over wide areas using simpler equipment and processing techniques than existing processes.

### BRIEF SUMMARY

According to the present disclosure, a method is disclosed for cutting or perforating a thin film that includes applying an energy-absorbing material at a selected location or at selected locations on a surface of the film, wherein the energy-absorbing material absorbs electromagnetic energy in a predetermined frequency range. Further, the method includes irradiating the energy-absorbing material at said location or said selected locations with a laser of sufficient energy in the predetermined frequency range, so as to heat the energy-absorbing material to an extent that a portion of the film adjacent to the energy-absorbing material is removed, thereby cutting the film or generating perforation in the film.

A further, significant, advantage of the present disclosure is that it relies upon application of the energy-absorbing material to a selected location or selected locations on the film so as to achieve the desired cutting or perforation, rather than manipulation of the laser so as to achieve the desired cutting or perforation. This represents a significantly simplified process.

### BRIEF DESCRIPTION OF THE SEVERAL VIEWS OF THE DRAWINGS

So that the manner in which the above recited features, advantages and objects of the present disclosure are attained and can be understood in detail, a more particular description of this disclosure, briefly summarized above, may be had by reference to the embodiments thereof which are illustrated in the appended drawings.

It is to be noted, however, that the appended drawings illustrate only typical embodiments of this disclosure and are therefore not to be considered limiting of its scope, for this disclosure may admit to other equally effective embodiments.

FIG. 1a depicts a schematic cross-sectional diagram regarding a method for cutting or perforating film in accordance with this disclosure.

FIG. 1b depicts a schematic cross-sectional diagram regarding a method for cutting or perforating film in accordance with this disclosure.

FIG. 1c depicts a schematic cross-sectional diagram regarding a method for cutting or perforating film in accordance with this disclosure.

### DETAILED DESCRIPTION

The following is a detailed description of example embodiments of this disclosure depicted in the accompanying drawings. The embodiments are examples and are in such detail as to clearly communicate this disclosure. However, the amount of detail offered is not intended to limit the anticipated variations of embodiments; on the contrary, the intention is to cover all modifications, equivalents, and alternatives falling within the spirit and scope of the present disclosure as may be defined by the appended claims. The detailed descriptions below are designed to make such embodiments obvious to a person of ordinary skill in the art.

The present disclosure finds particular use in the cutting and/or perforation of polymer films, typically thermoplastic polymer films. The polymer films may be thin films, which, for example, include films having a thickness of less than 25 μm to 5 μm or even less.

Suitable thermoplastic materials for the polymer films include, but are not limited to, polyesters. Examples of suitable thermoplastic materials include polyethylene glycol terephthalate (PET), polyethylene glycol naphthenate (PEN), polylactic acid (PLA), and films comprising polyester copolymers and polyester blends, wherein the foregoing have been described as components of digital stencils for use in digital duplicator printing processes. PET and PEN may be more ideal than other possible materials.

The film to be cut and/or perforated may be highly transparent, even fully transparent, to energy at the wavelength provided by laser radiation, so that the radiation is only absorbed at those selected locations of the film to which the energy-absorbing material has been applied. Otherwise, selective cutting or perforation could not be achieved.

Depending upon the manner in which the energy-absorbing material is applied to the film, for instance, if this is in the form of a continuous or substantially continuous line, or, in the form of a series or pattern of spots, the disclosed method is capable of achieving cutting and/or perforation of the polymer film. In order to achieve cutting it is not always necessary to have a continuous line of energy-absorbing material. Instead, a discontinuous line may be satisfactory provided that any gaps in the line are sufficiently small so as not to hinder cutting of the film on irradiation of the energy-absorbing material.

While the process is suitable for either cutting or perforating the polymer film, with regard to perforating, a wide variety of patterns and perforation geometries may be achieved at high speed. The perforations, themselves, may vary considerably in dimensions, for instance having an average (i.e., mean) diameter in the range from 0.1 to 250 μm, but the range could also be from 2 to 125 μm. In the context of the present disclosure, average diameter is the average of the maximum and minimum diameters of a perforation, as determined by optical or scanning electron microscopy (SEM). For some applications, the perforations may be substantially the same size, for instance varying in average diameter by only up to 10% or less. Purely by way of example, the method has readily achieved perforation patterns of 80 μm average diameter holes with 125 μm pitch in polymer films of around 4 μm thickness.

In addition to laser irradiation of the energy-absorbing material, other forms of irradiation may be envisaged, depending on the type of energy-absorbing material. For instance, it may be possible to use a halogen-type lamp, which emits energy primarily in the near infrared region of the electromagnetic spectrum.

Any suitable laser may be used for irradiation of the energy-absorbing material, depending upon the absorption characteristics of that material. Generally, however, the laser will still irradiate in the infrared region of the electromagnetic spectrum.

Irradiation of the energy-absorbing material may be conducted from the same side of the film as that to which the energy-absorbing material has been applied. However, alternatively, irradiation may be performed from the opposite side of the film to which the energy-absorbing material has been applied. The latter arrangement may be applicable to films having a thickness of less than 25 μm, provided, of course, that the film, itself, is able to transmit this energy to the energy-absorbing material on the other side of the film.

There are various ways in which the laser irradiation may be performed, including using a single laser beam, or an array of laser elements, for example a linear array of lasers. If continuous exposure of the thin film is required over the whole surface, then the laser array may be arranged to provide a stripe of continuous radiation rather than individual spots. Alternatively, if exposure of the thin film to the laser radiation is only required at selected locations, i.e., one or more locations, the lasers in the array may be arranged to fire independently and at appropriate times as the film to be perforated passes the laser array.

In one embodiment, a single laser beam is programmed to fire at set intervals and scanned across the surface of the film. Perforation only occurs at those locations of the film to which the energy-absorbing material has been applied. The advantage of this method is that there is no requirement for complex controls to address the laser at specific points to be perforated.

In another embodiment, where a laser array is used, the array may provide a plurality of single beams at a fixed position. The array may be programmed to fire at set intervals and moved across a fixed sheet of film, or, alternatively, the film itself may be passed under a fixed or static array, where, again, continuous or pulses of laser light may be emitted. Again, perforation occurs only at those locations on the film to which the energy-absorbing material has been applied. The advantage of this process is that it avoids a complex and expensive array design, and the need for an array driver with associated software to enable individual lasers to be addressed.

The laser array may be a so-called “laser bar”, in which a plurality of laser elements are provided on a bar that extends across the film to be perforated, and which comprises optical elements, typically including a lens mechanism, such as a cylindrical lens or microlens array to collimate the beam in the fast axis (perpendicular to the width of the bar) to create a narrow band of light. Diffraction of light in the slow axis (parallel to the width of the bar), or use of a microlens array or a beam homogeniser, may be used to create an approximately uniform intensity of light along the illuminated band of light.

In another embodiment, a semiconductor laser bar is used to create a continuous line of light transverse to the direction of motion of the film. The laser bar comprises a plurality of laser elements disposed across the width of the bar. A typical bar is 10 mm wide with typically 10 to 30 laser elements or more if the elements are narrow stripe. The fill factor of the laser elements is typically 30% to 90%. The output light may be, and is usually, single moded in the fast axis and may be, and is usually, multi-moded in the slow axis (parallel to the width of the bar).

In the context of the present disclosure, single-moded light is light that propagates in a single, transverse, moded beam with a Gaussian intensity profile and the wave fronts have a radius of curvature described by the Gaussian ray equation. The light propagates through space, lenses, etc. maintaining the Gaussian profile. Multi-moded light can be considered a superposition of many Gaussian beams.

The typical power of a 10 mm wide laser bar is 20 to 100 W, and typical wavelengths of operation lie in the range 800 to 1000 nm. However, the dimensions of the bar, the number of laser elements and power output may be varied according to the nature and dimensions of the film to be cut or perforated.

In order to create an illuminated line longer than the width of a single bar, a plurality of bars can be placed side by side. In this way the width of the illuminated line can be built up to 1 m or more, depending on the width of the film to be cut or perforated. Alternatively, two or more bars can be positioned at different locations along the length of the film (or in the web or machine direction), but then staggered across the width of the film, so that all of the film width is exposed approximately uniformly.

A laser bar may be used in the present disclosure as a direct laser source, or, it may be used to optically pump another laser, such as a solid state laser or fiber laser, thereby achieving improved beam quality in the slow axis. Other ways of improving beam quality, if desired, may be desired and are within the scope and spirit of this disclosure.

The laser source, whatever form this might take, may be configured to provide continuous or pulsed radiation, depending on the characteristics of the film to be cut or perforated, and the degree of cutting or perforation required. It may be desirable to provide relative motion of the film, and one or each of the devices used to apply the energy-absorbing material, e.g., a print head, and/or the laser. The foregoing can be achieved by movement of the film or movement of the print head, or the laser, or both. In one arrangement, the laser beam may be scanned across the surface of the thin film, and fired at appropriate moments or continuously, depending on the location(s) to which the energy-absorbing material has been applied.

In one embodiment, the film to which the energy-absorbing material has been applied is pre-heated prior to irradiation with the laser. Pre-heating can have the effect of reducing the amount of laser energy required and/or of accelerating the process. Further, pre-heating may also reduce stresses in areas of the film to which the energy-absorbing material has not been applied, and, thereby, avoiding undesirable deformation or cracking of the film in those areas.

The energy-absorbing material may be any suitable material capable of absorbing sufficient energy to affect local heating of the thin film to cause vaporization or melting, and, may be a material that can be printed by known printing processes, including non-impact printing processes, such as inkjet printing and other processes such as flexographic, gravure and rotary screen printing. Exemplary energy-absorbing materials include absorbers such as: cyanines, squaryliums and croconiums (for absorption of optical radiation at, e.g., 845 nm wavelength); imminiums and di-imminiums (for absorption at, e.g., 1090 nm wavelength); nickel dithiolates (for absorption, e.g., in the range 720 to 1200 nm wavelength); phalcyanines (for absorption, e.g., in the range 700 to 100 nm wavelength); azo dyes and azo-based dyes, such as food black 2; and carbon black.

The energy-absorbing materials may be dissolved or dispersed in a suitable solvent to facilitate application to the film to be cut or perforated. It may also be used with a variety of adjuvants, such as humectants, surfactants, penetrants and/or binders, which may assist in rendering the energy-absorbing material more suitable for application to the film. Embodiments of the present disclosure will now be described by way of example and with reference to the accompanying drawings.

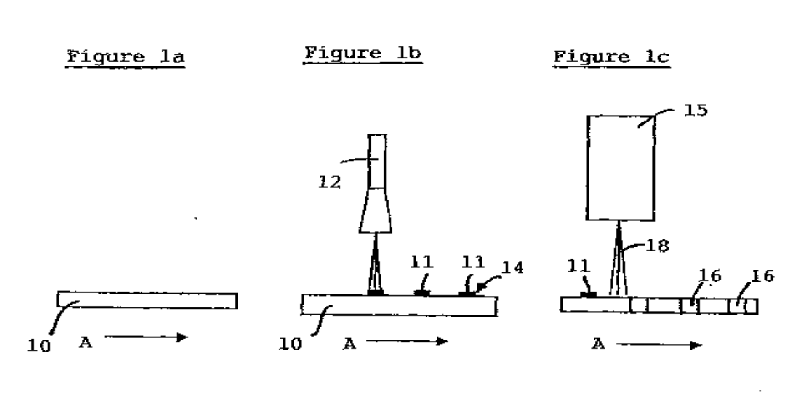

With reference to FIG. 1a, a film material 10, such as a polymer thin film, is provided and may be highly transparent to, and absorb little energy, at the wavelengths produced by commonplace lasers, such as diode lasers. As used herein, the expression “laser” is intended to encompass any optical device suitable for generating a high energy, highly spatially localized, optical output sufficient for the purposes described, without necessarily being a coherent light source. In FIG. 1a, the film is moved in the direction of arrow A, as indeed it is in FIGS. 1b and 1c described below.

With reference to FIG. 1b, an energy-absorbing material 14 is applied to the thin film 10 at one or more, selected, discrete locations 11 by way of a suitable printing device 12. In one arrangement, the printing device 12 may be an inkjet print head although other types of printing devices may be used. The printing device 12 may provide a pattern of energy-absorbing material 14 at which apertures in the thin film 10 are to be formed.

With reference to FIG. 1c, the energy-absorbing material is subsequently irradiated with electromagnetic energy from a laser source 15. The laser source has an optical output 18 directed along an optical axis of the laser which generates a predetermined spot size at a predetermined distance from the laser output. The laser source 15 is configured such that it produces an optical output beam 18 of sufficient energy, in the absorption frequency range of the energy-absorbing material, such that the resultant heat generated by the laser beam in the energy-absorbing material is sufficient to remove by ablation, e.g., by vaporization or melting a portion of the thin film, adjacent to the energy-absorbing material to form perforations or apertures 16. In the arrangement shown in FIG. 1c, the portions of thin film 10 that are removed to form the perforations or apertures 16 are substantially coextensive with the area of the printed energy-absorbing material. In other words, the aperture size and position are substantially determined by the printed image of energy-absorbing material as defined by the printing device, assuming that the laser beam 18 irradiates all relevant areas. With existing print head technology, very precise control of both spot size and position of printed imaged is possible even when being applied to a moving substrate, such as when film 10 is being passed thereunder. Precise control over the irradiating energy is not required, since energy will only be absorbed sufficient to remove portions of the film 10 at the one or more selected locations defined by the printed energy-absorbing material 14. Elsewhere, any laser energy impinging on the thin film will generally be insufficiently absorbed by the thin film 10 to achieve vaporization, melting or other removal of the thin film.

In the embodiment described above, the control of aperture size and position can be determined largely or wholly by control of the printed area of energy-absorbing material, and, thereby, providing a simple and efficient process. However, it will be recognized that control of the aperture size and position can additionally be controlled by manipulation of the laser 15. For example, the printed areas 11 of energy-absorbing material may be made larger than required for the perforations or apertures 16, and control of the laser beam spot size and position where it impinges on the thin film 10 may be used to determine the extent of the formed apertures 16.

The extent of thin film removed by the laser energy may be determined by several factors. The areal extent and optical density of energy-absorbing material and the power and areal coverage of the laser energy applied, together, will determine the amount of heat transferred into the thin film. This may be somewhat larger than the defined area of the energy-absorbing material if sufficient thermal energy is conducted in the thin film. The optical energy required to cause thin film removal will also depend on ambient conditions. The energy-absorbing material may be applied to the selected location(s) on the film using other printing techniques. For example, the energy-absorbing material may be applied to the thin film 10 as a continuous or semi-continuous layer, and then patterned using a selective removal process to remove unwanted portions of energy-absorbing material, leaving only the desired selected locations 11.

In the arrangement of FIGS. 1a to 1c, the methods of applying the energy-absorbing material to the thin film 10 and subsequent laser exposure thereof are performed using a suitable transport mechanism that achieves relative motion between the thin film and each of the printing device and the laser. These methods may be carried out independently using separate process equipment, or they may be carried out sequentially in a single machine using the same transport mechanism to drive the thin film past both the print head 12 and the laser 15.

The thin film 10 may be physically self-supporting material that may be delivered by the delivery mechanism, e.g., provided on a roll. However, the method could be applied to other thin films inherently incapable of being self-supporting. In this latter case, the thin film 10 may be provided on a suitable substrate or carrier film from which it can be detached later after processing. The substrate or carrier film may be one which does not absorb significant quantities of energy from the laser, and which, therefore, does not significantly contribute to the thermal material removal process. The substrate or carrier film may have a low thermal mass to avoid acting as a heat sink inhibiting the thermal removal of thin film material by the laser.

Where the method of the present disclosure is used for cutting a thin film, it may find use in reel slitting, where rolls of web material are cut in the web, or machine direction to provide reels of reduced width and/or to remove unwanted edge material, or in label cutting, where individual labels are cut from a continuous web of label stock located by a pressure-sensitive adhesive on a release liner material.

While the foregoing is directed to example embodiments of this disclosure, other and further embodiments of this disclosure may be devised without departing from the basic scope thereof, and the scope thereof is determined by the claims that follow.

What is claimed is:

1. A method of cutting a thin film, the method comprising:
applying an energy-absorbing material at one or more selected locations on a surface of the thin film, wherein the energy-absorbing material absorbs electromagnetic energy in a predetermined frequency range; and
irradiating the energy-absorbing material at the one or more selected locations with a laser of sufficient energy in the predetermined frequency range, so as to heat the energy-absorbing material to an extent that a portion of the thin film adjacent to the energy-absorbing material is removed, thereby providing the cutting of the thin film.

2. The method of claim 1, wherein the cutting comprises perforating.

3. The method of claim 1, wherein the applying comprises applying the energy-absorbing material as a spot so as to generate a perforation in the thin film upon the irradiating of the energy-absorbing material.

4. The method of claim 1, wherein the applying comprises applying the energy-absorbing material as a plurality of spots.

5. The method of claim 1, wherein the applying comprises applying the energy-absorbing material as a plurality of spots having a pattern.

6. The method of claim 1, wherein the applying comprises applying the energy-absorbing material in a line such that the irradiating of the energy-absorbing material provides the cutting of the thin film.

7. The method of claim 1, wherein the applying comprises applying the energy-absorbing material in a continuous line such that the irradiating of the energy-absorbing material provides the cutting of the thin film.

8. The method of claim 1, wherein the applying comprises applying the energy-absorbing material to the thin film using a print head.

9. The method of claim 1, further comprising providing relative movement between the thin film and a print head, and actuating the print head for the applying of the energy-absorbing material when the one or more selected locations of the thin film are aligned with the print head.

10. The method of claim 9, wherein the relative movement is provided by transporting the thin film relative to the print head.

11. The method of claim 10, wherein the transporting comprises transporting with a roller transport mechanism.

12. The method of claim 9, wherein the relative movement is provided by scanning the print head over the surface of the thin film.

13. The method of claim 1, wherein the applying comprises applying the energy-absorbing material to the thin film as a continuous, wherein the method further comprises subsequently removing portions of the energy-absorbing material so as to leave the energy-absorbing material only at the one or more selected locations on the thin film.

14. The method of claim 1, wherein the applying comprises applying the energy-absorbing material to the thin film as a semi-continuous layer, wherein the method further comprises subsequently removing portions of the energy-absorbing material so as to leave the energy-absorbing material only at the one or more selected locations on the thin film.

15. The method of claim 1, wherein the irradiating of the energy-absorbing material comprises irradiating by an array of lasers.

16. The method of claim 15, wherein each laser in the array has an output which is combined with the output of each other laser in the array, so as to form a continuous line of laser energy.

17. The method of claim 1, wherein the irradiating of the energy-absorbing material comprises irradiating at a plurality of the one or more selected locations at the same time using multiple laser elements in a laser array.

18. The method of claim 1, wherein the irradiating of the energy-absorbing material comprises irradiating with an infra-red laser.

19. The method of claim 1, further comprising providing relative movement between the thin film and the laser.

20. The method of claim 19, wherein the relative movement is achieved by moving the thin film past the laser.

21. The method of claim 20, wherein the moving comprises moving with a roller transport mechanism.

22. The method of claim 19, wherein the relative movement is provided by scanning the laser over the surface of the thin film.

23. The method of claim 1, further comprising operating the laser only at times when the one or more selected locations on the thin film are aligned with an optical axis of the laser.

24. The method of claim 1, wherein the thin film comprises a polymer film.

25. The method of claim 1, wherein the thin film comprises a thermoplastic film.

26. The method of claim 1, wherein the thin film comprises a thickness of less than 25 μm.

27. The method of claim 1, further comprising preheating the thin film prior to the irradiating of the energy-absorbing material.

28. The method of claim 1, wherein the energy-absorbing material comprises one or more materials selected from a type consisting of a cyanine, a squarylium, a croconium, an imminium, a di-imminium, a nickel dithiolate, a phalpcyanine, an azo dye, an azo-based dye, and carbon black.

29. The method of claim 1, wherein the irradiating of the energy-absorbing material comprises irradiating from the side of the thin film to which the energy-absorbing material has been applied.

30. The method of claim 1, wherein the irradiating of the energy-absorbing material comprises irradiating from the opposite side of the thin film to which the energy-absorbing material has been applied.
